(19) United States
(12) Patent Application Publication
(10) Pub. No.: US 2002/0178608 A1
(43) Pub. Date: Dec. 5, 2002

(54) Method and apparatus for the production of lumber identical to natural Bog oak

(76) Inventor: Aleksandrs Leonovs, Balta (LV)

Correspondence Address: Michael I. Kroll, 171 Stillwell Lane, Syosset, NY, 11791, US

(21) Appl. No.: 09/849,284

(22) Filed: May 4, 2001

(51) Int. Cl. F26B 7/00

(52) U.S. Cl. 34/418

(57) ABSTRACT

An apparatus and method forth production of timber identical to natural Bog oak is described. More particularly, the improved method comprises the steps of (A) loading timber to be treated into a reactor (B) capsulizing the reactor (C) vacumizing the reactor (D) blowing ammonia into the reactor (E) increasing the temperature in the reactor (F) repining of the timber contained in the reactor (G) decreasing the temperature (and pressure) in the reactor (H) hydrothermal process of the timber in the reactor, and then (I) finally removing the finished timber from the reactor which now has qualities similar to Bog oak wood. The entire method takes no longer than 120 hours—which replaces the natural method of creating the same quality of wood thousands of years

### BACKGROUND OF THE INVENTION

1. Field of the Invention

The present invention relates to a new chemical method, and a subsequent physical method, which process inside the structural timber elements and refine the natural oak timber integrally by recent technology until the quality of the timber becomes similar to Bog oak timber. More particularly, the process of the present invention involves a sequence of steps under controlled conditions of time, temperature and pressure, and in particular, a steam-air-ammonia composition added to the timber. The invention also relates to wood treated in accordance with the method of the invention. The method of the invention can be carried out on a wide variety of wood types. The actual time of contact of the wood with the solutions in step (A) will vary depending on a variety of factors such as, for example, (1) the level of pressure within the vessel, (2) the difficulty of penetration into the particular type of wood being treated and (3) whether the wood is green wood or seasoned wood. Any type of wood, dry or green, can be treated with the solutions of the invention. Green wood generally is defined as wood containing 30% or more by weight of water. Dry or seasoned wood is defined as wood containing less than 30% by weight of water based on bone-dry wood. Examples of wood species which can be treated in accordance with the method of the invention include Southern Yellow Pine, Western Red Cedar, Douglas Fir, Inland Fir, Spruce, Hemlock, Sugar Maple, Ash, Walnut, Cherry, White Pine, Red Pine, Birch, Red Oak, White Oak, Elm, Hickory, Linden, Beech, Sycamore, etc.

2. Description of the Prior Art

In order to prevent decay of wood and timbers, and thereby increase their life, it is common practice to impregnate the wood or timbers with a preservative such as creosote, mixtures of inorganic compounds, which are dissolved or dispersed in water, or certain organic compounds, which are dissolved in petroleum distillates. The protection afforded by the application of these materials is dependent upon deep and reasonably uniform penetration into the wood or timber by the preservative material.

The subject of wood treatment and wood preservation is discussed in some detail in the two volume treatise entitled “Wood Deterioration and its Prevention by Preservative Treatments”, Darrel D. Nicholas, Editor, Syracuse Wood Science Series 5, Syracuse University Press, Syracuse, N.Y., 1973. Among the examples of wood preservatives described therein are various creosote compositions, pentachloro-phenol, copper naphthenate, copper-8-quinolinolate, organotin compounds, organomercury compounds, zinc naphthenate, chlorinated hydrocarbons, ammoniacal copper arsenite (ACA), acid copper chromate (ACC), zinc salts such as zinc chloride, zinc oxide and zinc sulfate, chromated copper arsenate (CCA), etc.

Processes and equipment for treating wood are discussed in Volume II, Chapter 3, pages 279-298. The pressure treatment is described as the most effective method of protecting wood against attack of decay, insects, fire, etc. Non-pressure treatments also are discussed in this chapter. Dipping is suggested primarily as a satisfactory surface treatment although some penetration is observed. Another non-pressure technique is the diffusion process with unseasoned wood. The author indicates the process requires long treating periods because of slow diffusion rates.

Wood preservatives such as those described above have been applied to the wood as solutions, emulsions, pastes or dispersions in liquid hydrocarbons and/or aqueous systems. In many applications, the use of aqueous systems is preferred over liquid hydrocarbons because of the odors, flammability and often-toxic nature of the liquid hydrocarbons.

Regardless of the impregnating chemical system employed, the most common commercial procedure for impregnating wood involves subjecting wood to the preservative under relatively high pressures such as 150 to 200 pounds to the square inch for a substantial period of time such as from one hour to 24 hours. The process also may require relatively high temperatures such as from about 75° C. to about 90°to 95° C. Moreover, the application of pressure can cause compression of the outer layers of the wood, particularly after wood is weakened and softened by steaming. The collapse of the wood cells is likely to occur especially when relatively soft, unseasoned wood of low specific gravity is being treated. On collapse of the wood cells in an area, there is formed a relatively impenetrable layer which restricts or even completely blocks the flow of preservatives into the interior of the wood.

It also has been suggested to improve the method of pressure treatment by first subjecting the wood to a vacuum treatment.

As mentioned above, the most common commercial procedure for impregnating wood involves subjecting the wood to the preservative under relatively high pressures and sometimes at relatively high temperatures. Normally, the procedure involves placing the wood in a vessel, filling the vessel with the preservative mixture and raising the pressure within the vessel to the desired level to effect penetration of the solution into the wood. Sometimes, the temperature of the liquid within the vessel is raised to an elevated temperature. After the wood has been subjected to the penetrating system for the desired period of time, the pressure is reduced, generally, to atmospheric pressure, and as the pressure is reduced, some of the penetrating solution contained in the wood is forced out of the wood by expansion of the air within the wood as the external pressure is reduced. This penetrating solution, which is released and recovered from the wood as the external pressure is reduced, is generally referred to in the art as “kickback”. When the term is used in this application, it shall have the same meaning. We have observed in processes where the penetrating solution contains metal salts of carboxylic acids that the kickback often contains less metal and more carboxylic acid than was originally in the penetrating solution. The compositional change in the kickback is a problem because the kickback generally is mixed with the original solution in the vessel thereby resulting in an overall reduction in metal content and an increase in acid. Although the decrease in metal concentration in the solution can be adjusted by adding additional metal salt, the increased amount of free acit within the solution cannot be easily removed, and the concentration continues to build up as the process is continued. In addition to the dilution effect caused by the increased acid, the surplus of acid present in the mixture can lead to mild steel corrosion problems in wet systems.

Numerous types of methods of refining timber have been provided in the prior art. For example, U.S. Pat. Nos. 3,995,077; 4,027,401; 4,339,479; 4,937,143; 5,330,847; 5,395,656; 5,970,624; 6,065,224 and 6,123,754 and Canadian Patent Numbers 1,119,352 and 1,250,701 all are illustrative of such prior art. While these prior patents may be suitable for the particular purpose to which they address, they would not be as suitable for the purposes of the present invention as heretofore described. In particular these prior methods impregnate timber using dyestuffs or substances, which increase the time of the timber's useful life. Other prior art methods include chemical dyeing or consolidation in different timber combinations and forms. However, no prior art is able to make timber having qualities that duplicate the high qualities of Bog oak timber as disclosed in the instant application.

Detailed below is a more detailed description of the disclosures made in each of the relevant prior art patents.

### U.S. Pat. No. 3,995,077

### Inventor: Bror Olof Hager

### Issue Date: Nov. 30, 1976

Wood is impregnated with a solution of a preservative in a vaporizable, water-free, organic solvent and thereafter treated with a warm high-boiling oil composition under sub atmospheric pressure conditions effecting evaporation of the solvent used in the impregnation step.

### U.S. Pat. No. 4,027,401

### Inventor: John B. Fairbanks, Jr.

### Issue Date: Jun. 7, 1977

Apparatus and process for curing and/or treating wood items such as logs and cut timber. In one form of the invention a baffle is medially interposed in a closed chamber, separating such chamber into positive and negative pressure compartments, such baffle clamping to the timber to be cured. A vacuum pump applies pressure to one compartment within the vessel and vacuum to the remaining compartment of the vessel, for the purpose of aiding with the withdrawal of resin from the wood. A resin solvent or diluent is introduced at the pressure side for rendering less viscous the resin contained in the timber, to thereby aid in its travel through and withdrawal from such timber. The return circuit to the vacuum pump includes a resin collector and also a water-moisture trap. Other fluid additives such as fireproofing and anti-rotting fluid materials may be introduced in the pressure side of the vessel. In a second embodiment, a tree trunk is held vertically in the field at the sites of its cutting and is supplied vacuum and pressure for curing and/or treating such trunk as a log prior to transport. In a third embodiment of the invention centrifugal force is relied upon to aid in the recovery of the resin from lumber or logs being cured.

### Canadian Patent Number 1,119,352

### Inventor: Bror O. Hager

### Issue Date: Mar. 9, 1982

An improved method for the preservation of wood (hardwood) by treatment thereof with a preservative solution is disclosed. The wood is treated with a special preservative solution and is then kept in undried condition for a period of time sufficient to allow the preservative solution to penetrate the wood and diffuse through the cell walls of the wood without fixation thereof. The wood is then dried so as to fix the preservative. Enhanced periods of preservation effectiveness are thus obtained.

### U.S. Pat. No. 4,339,479

### Inventor: Edward Robbart

### Issue Date: Jul. 13, 1982

A process for rendering cellulosic material water repellent that requires no subsequent neutralization step while retaining the desired water repellent and strength characteristics thus provided by selecting a cellulosic material having a water content of up to about 10% preferably below about 2% and contacting the material with vapors of a lower alkyl silicon halide during which contacting the concentration and temperature of the halide vapor, the pressure within the treating chamber and the contact time are all maintained so as to provide a water repellent cellulosic material having a pH greater than 2.5. In one aspect of the invention, the cellulosic material subjecting to contacting is substantially frozen and in another aspect contacting is conducted under vacuum.

### Canadian Patent Number 1,250,701

### Inventor: Robert M. Leach

### Issue Date: Mar. 7,1989

The present invention provides a method and composition for preserving wood and other cellulose based materials against destructive organisms responsible for rot and decay, namely fungus and insects. The composition comprises an aqueous ammoniacal solution of a preservative metal compound and an organic acid selected from the group consisting of aliphatic dicarboxylic acids containing 2-10 carbon atoms per molecule, aliphatic mono, di or tricarboxylic hydroxy acids containing 2-6 carbon atoms per molecule or a mixture of these acids and/or their salts. The preservative composition may be applied by dipping, soaking, spraying, brushing or by any other well-known means including vacuum and/or pressure applications.

### U.S. Pat. No. 4,937,143

### Inventor: Michael H. West

### Issue Date: Jun. 26, 1990

A method for both preserving and coloring wood which comprises in a first step contacting the wood with a liquid composition containing a biocidally effective amount of a copper compound, and in a second step contacting the wood with a liquid composition containing a biocidally effective amount of a dithiocarbamate compound selected from the group consisting of alkyl dithiocarbamates, alkylene dithiocarbamates and soluble salts therof.

### U.S. Pat. No. 5,330,847

### Inventor: Richard J. Murphy, et al.

### Issue Date: Jul. 19, 1994

A method of treating moisture containing wood including the step of exposing the timber or wood to a vaporous azeotrope of an organ-boron component and an alcohol at a temperature below the alcohol's boiling point. The organ-boron compound hydrolyses with the moisture to form boric acid in the timber or board.

### U.S. Pat. No. 5,395,656

### Inventor: Jin Liang

### Issue Date: Mar. 7, 1995

A wood preservative composition, which contains polyethylene oxide along with poly vinyl pyrrolidone, is applied to woodin a four-step process. In the first step, moisture and excess resin are removed from the wood. In the second step, the preservative composition is applied to the wood by pressure injection. In the third step, the reactor for the wood is drained and excess solution is transferred to a holding tank. In the fourth step, a catalyst, either heat or a low-pH composition, is applied to the wood to cause chemical bonding of the preservatives within and with the wood. As a part of the fourth step, excess moisture is removed from the wood by subjecting the wood to a vacuum to draw out excess moisture and then subjecting the wood to a flow of desiccated air, which absorbs the moisture.

### U.S. Pat. No. 5,970,624

### Inventor: Kazuo Moriya

### Issue Date: Oct. 26, 1999

The invention aims to provide a timber drying method, which can dry timbers in a short period without causing cracks and a timber impregnation method to permeate processing agents deep into the timbers at a low cost. The timber drying method comprises a process to place lumbers in an airtight reactor and to heat them, a process to vacuum the inside of the airtight reactor, and a process to restore the air pressure after the vacuuming process. And, the lumber impregnation method comprises a process to heat lumbers, a process to place the heated lumbers under a vacuumed pressure, a process to immerse the heated lumbers in processing agents under the vacuumed pressure, and a process to restore the pressure of the lumbers immersed in the processing agents under the vacuumed pressure of the air pressure, and to immerse the lumbers in the processing agents under the air pressure.

### U.S. Pat. No. 6,065,224

### Inventor: Erich Eigner

### Issue Date: May 23, 2000

A device for the aerobic treatment, conditioning and/or drying of moist, substantially solid or paste-like, at least partly organic material, has a vessel containing paired, Venetian-blind-like walls, with adjustable blades, forming at least one reaction chamber, at least one air inlet chamber and at least one air discharge chamber, and containing supports which are in spatially staggered array inside the reaction chamber in such a way that they provide the possible pressure relief for the filling. The invention also related to a process using device.

### U.S. Pat. No. 6,123,754

### Inventor: Werner Handl

### Issue Date: Sep. 26, 2000

The invention relates to a wood-impregnating agent, which is an emulsion, dispersion or solution of a cationic, quaternary, amphoteric and/or special non-ionic surfactant, the surfactant or surfactants being poorly soluble in water and the dispersion or emulsion having a mean particle size diameter or a mean droplet size diameter smaller than 1 .mu.m. Preferable surfactants include cationic and/or quaternary surfactants or compounds from the group of imidazolines, benzyls, alkyls, dialkyls, monoalkyl-trimethyl, dialkyl-dimethyl, methyl-dialkoxy-alkyl, dialkylmethylbenzyl, diamidoamine and/or cationic and/or quaternary surfactants or compounds from the group of complex diquaternary compounds and/or the group of compounds which assume a cationic character in acid medium and/or non-ionic compounds from the group of fatty amine oxides, amine ethoxylate, and/or adducts of an ethylene oxide, which can be protonated on an heteroatom and/or amphoteric compounds from the group of betaines and/or ampholytes. For the use of the impregnating agent the boards to be impregnated are first placed in a steel reactor and secured against floating, then the reactor together with its contents are evacuated and left with a vacuum of 80 to 95% for 10 to 25 minutes. Afterwards the impregnation liquor is introduced into the reactor while destroying the vacuum and the wood kept in it for 1 to 6 hours. Thereafter first the impregnation liquid and then the wood is removed from the reactor.

### SUMMARY AND OBJECTS OF THE PRESENT INVENTION

The present invention relates generally to Bog oak timber and, more specifically, to an industrial method of making timber having the qualities of Bog oak timber.

A primary object of the present invention is to provide a method, which can commercially change the qualities of timber to the higher qualities of Bog oak timber.

Another object of the present invention is to provide an apparatus and equipment for refining oak timber into timber having qualities of Bog oak.

A further object of the present invention is to provide a commercial method and apparatus which is inexpensive to operate yet which will create Bog oak timber that will be superior in qualities to all prior known wood products.

Another object of the present invention is to provide wood treating apparatus that is simple and easy to use.

Additional objects of the present invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated at the same becomes better understood when considered in conjunction with the accompanying drawings, in which like reference characters designate the same or similar parts throughout the several views.

FIG. 1 is a side perspective view of the industrial apparatus for treating timber and giving it qualities equal to that of Bog oak timber;

FIG. 2 is an enlarged side perspective view of the timber reactor and the attached reservoirs for treating timber and giving it qualities equal to that of Bog oak timber.

FIG. 3 is a list showing the steps used in the above apparatus for treating timber and giving it qualities equal to Bog oak timber.

### DESCRIPTION OF THE REFERENCED NUMERALS

Turning now descriptively to the drawings, in which similar reference characters denote similar elements throughout the several views, the Figures illustrate the method of the present invention. With regard to the reference numerals used, the following numbering is used throughout the various drawing figures.

1 The reactor with loaded technical bogie and special thermal blowing equipment to maintain the definitely equal temperatures and gas vapor fields.

2 Vacuum pump.

3 The special gas equipment, which provides the ration of the request level of the percentage oxygen content in the mixture of vapor-air-ammonia.

4 The liquid ammonia capacity.

5 The regenerate blowing equipment, which provides the reactivation and blowing of the non-activated ammonia to the special capacity.

6 The absorbing column for the concentration of the non-activated ammonia.

7 The control desk, which includes the control and measure control equipment, including electronic computer.

Line a-b—the ammonia gas reactor supply main, which is replenished by the ammonia supply batch equipment and reducing equipment.

Line c-d—the air supply main, which comes from the special gas equipment to provide request percentage oxygen content inside of the reactor.

Line e-g—the air supply main, which comes from the reactor to the special gas equipment to provide request percentage oxygen content inside the air medium of the reactor.

Line h-j—the emergency non-activated ammonia pressure effluent main, which comes from the reactor to the absorbing column to provide automatic pressure reduction in the reactor in case of emergency, avoiding gas blowouts to the environment. The main is replenished by the special automatic valve and by the equipment, which provides the self-made control of any air gas blend pressure limit level inside the reactor in any nonordinary cases and without men's part.

Line e-f—the air main, supplies the air to the vacuum pump from the reactor during reactor pressure reduction.

Line i-j—the air main, which supplies the air the nonactivated ammonia assemblage-absorbing column from the vacuum pump. Also it is used as the emergency main in case of reactor pressure reduction, by means of the vacuum pump of the vapor-air-ammonia-mixture, until the pressure inside the reactor becomes lower then atmosphere pressure.

Line k-l—the gas mixture supply main, which comes from the non-activated ammonia-absorbing column to the regenerated blowing equipment.

Line m-n—the ammonia water supply main, which comes from the non-activated ammonia-absorbing column to the regenerate blowing equipment.

Line o-p—the reactivated and watered ammmonia supply main, which comes from the regenerate blowing equipment to the ammonia capacity.

### DETAILED DESCRIPTION OF THE PREFERRED EMBODIMENT

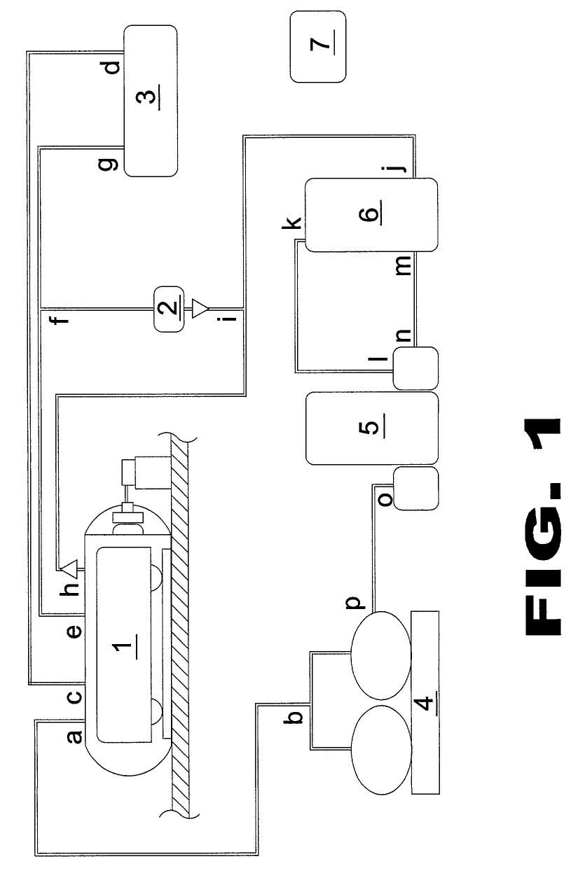

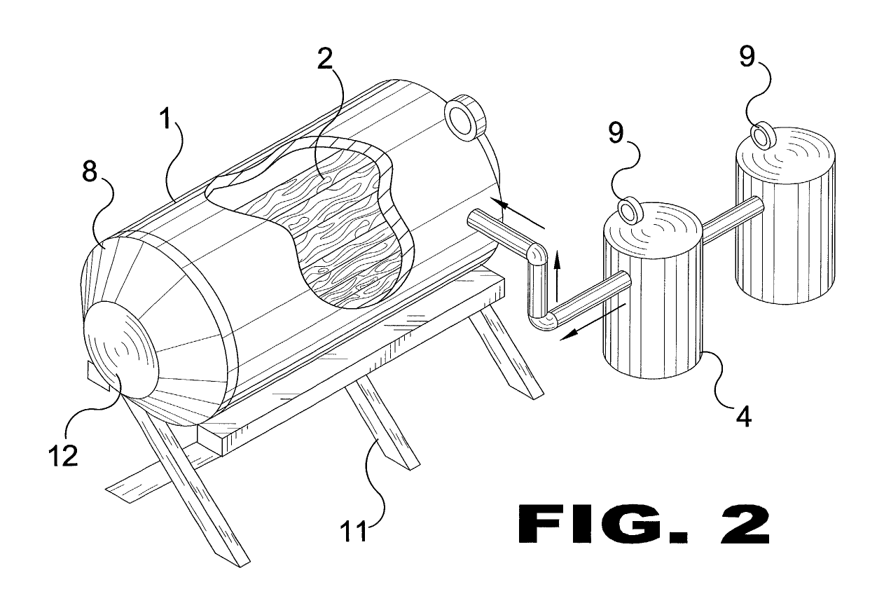

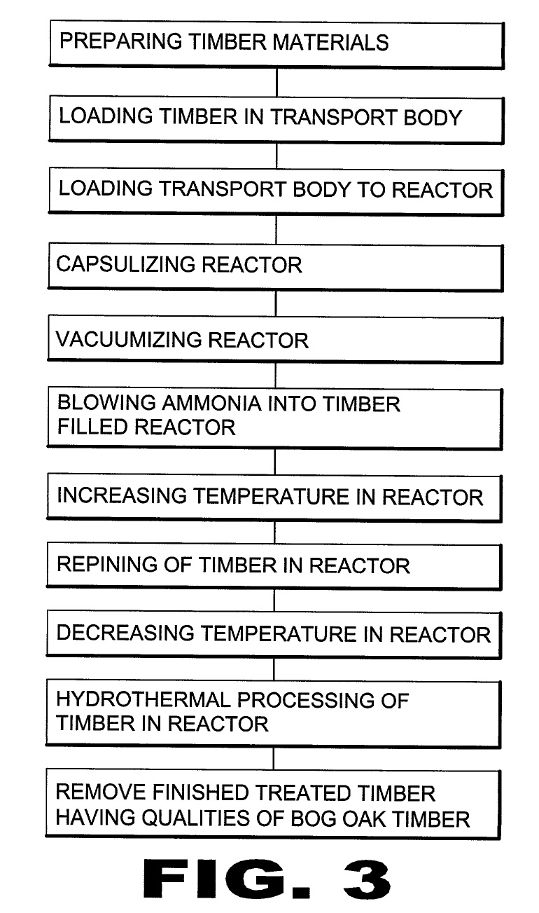

Turning now descriptively to the drawings, in which similar reference characters denote similar elements throughout the several views, FIGS. 1 through 3 illustrate the method and apparatus for the production of lumber identical to natural Bog oak.

The Apparatus of the Industrial Timber Treating Method

Having taking into consideration the need to solve the problem of providing a technological procedure for creating wood similar to Bog oak wood, the industrial complete cycle complex hydrothermal processing equipment was designed, installed and placed in operation to produce the treated timber products in lots. The description of the equipment follows:

The reactor 1—all requested operating factors of the processing medium of each technological stage are produced inside the reactor 1. The main distinctive feature of the reactor 1 construction consists in the fact that its component parts provide to keep the constant level of accurate equal temperatures and gas-vapor fields—this is a requisite condition of defect free treated timber production. An exemplary embodiment of the capacity for setting into operation the reactor 1 is 4.5 cubic meters.

The ammonia-gas equipment provides storing, dosed supply, assemblage and regeneration of the non-activated ammonia.

The special gas equipment 3 provides the establishment of the request oxygen concentration of the air sphere of the vapor-air-ammonia mixture.

The measure controlling and monitoring equipment provides the control of the processing medium requested operate factors for every technological stage, and also provides the monitoring of the main and subsidiary equipment manually and automatically.

The subsidiary equipment provides the establishment of the specified operating factors, which are not provided by the main equipment, and also for the subsidiary procedures.

The Method of Using the Apparatus for the Bog oak timber industrial manufacture inside the reactor 1:

1) The basic materials and loading to the transport technical bogie. The time expended on this stage of the method depends on the kind of equipment used.

2) The loading of the transport bogie to the reactor and its capsulation. The time expended on this stage of the method depends on the kind of equipment used.

3) Vacuumizing the reactor 1, the temperature increasing and the percentage oxygen content reduction in processing air medium. The time expended on this stage of the method depends on the sizes of the basic materials and lasts 30 minutes-2 hours;

4) Blowing of the ammonia into the reactor 1 until the vapor-air-ammonia medium reaches the requested pressure level. The time expended on this stage of the method depends on the kind of equipment used;

5) Increasing the temperature in the reactor 1 up to the requested level. The time expended on this stage of the method depends on the kind of equipment used, but the temperature increase should be done at a tempo so that the temperature difference between external and internal timber levels should not be more than 5 degrees centigrade;

6) The repining of the basic materials inside the established medium. The time expended on this stage of the method is no more than 72 hours;

7) Decreasing the temperature down to the level of the first stage of the hydrothermal processing chosen rate. The time of the stage depends to every kind of equipment separately, but the temperature decrease should be done at a tempo so that the temperature difference between external and internal timber levels should not be more than 5 degrees centigrade;

8) The substitution of the initial processing assortment stuff by the atmospheric air, the storing and regeneration of the non-activated ammonia. Practically the stage is combined with the temperature increasing stage;

9) The hydrothermal processing is processed according to the rate, which chose depends on the kind of the basic material and requested level of humidity. Practically it takes some more time than it is needed to dry another kinds of the deciduous tree timber of the same sizes and humidity,

Generally the overall method listed above takes no more than 120 hours.

In case of using the subsidiary drying equipment for the hydrothermal processing, which is able to make this procedure according to its characteristics, the requested stages are added to transport the processed material from the reactor to the subsidiary equipment. The stage can be processed manually and automatically.

Describing the technological rate standards, the standards of the vacuum concentration, the percentage oxygen content in the air sphere, the pressure of the processing assortment agents and the hydrothermal processing rates are not included.

### The Qualities of the Bog Oak Timber, Which is Generated Naturally and Industrially

It is not possible to describe all Bog oak timber advantages over any other timber. In short, even if one were to describe only the physicomechanical and exploitable qualities. These advantages are well known to those skilled in the art. Only the main features of the qualities are included.

In the present and following sections the term “the Bog oak timber” should be understood as the timber, which is generated naturally and also which is manufactured by the foregoing industrial method disclosed herein, using the described apparatus and technological procedure standards, because the qualities of these two timber kinds are similar to each other.

### The Surface Appearance

Being stained in dark brown and black colors, the beautiful texture of the nature oak timber cutting bits improves the surface appearance of the Bog oak timber, accenting its texture. The staining excels by its evenness and stability to the environment factors including the influence of the light and temperature. The spectrum characteristics of its staining depth do not change even after many hours processing in boiling water.

### The Physicomechanical Qualities

Some of the mechanical qualities of the natural oak timber and the Bog oak timber listed below

CHART

| | Natural Oak | Bog Oak |
|---|---|---|
| Exponent | Timber | Timber |
| Density, measured in kg./cc | 680 | 880 |
| 1. Statistical bending | 105 | 156 |
| 2. Pressure in the line of fibers | 52.8 | 99 |
| 3. Cleavage | 0.69 | 0.97 |
| 4. Pull in the line of fibers | 106 | 163 |

The firmness, measured in mega rascals

| | | |
|---|---|---|
| 1. Front | 60 | 112 |
| 2. Side | 50 | 86 |
| Scuff qualities, measured in kg/cc | 0.27 | 0.11 |

The dehumidification qualities

| | | |
|---|---|---|
| 1. Water absorbing in 2 hrs. (%) | 15.2% | 8.1% |
| 2. Water absorbing in 30 days (%) | 112.4% | 78.6% |
| 3. Dehumidification in 1 day (%) | 6.7% | 4.1% |
| 4. Dehumidification in 30 days (%) | 22.5% | 18.8% |

As the foregoing CHART shows, the Bog oak timber has a higher density as a result of its chemical densification, known in scientific fiction as “true densification”, causes improvement to the physic mechanical and exploitable qualities, which practically appears in quality to successfully resist environment influence, including the abrasive deterioration, the timber destructive fungus tolerance. There are known cases of integrity of the Bog oak timber inside the things, which had been made thousand years ago.

The changes of the Bog oak timber deformed qualities in comparison with the natural oak timber are of no small importance in the technical view. They appear in ability to deform under the special humidity-temperature conditions without any defects and easier in 2-3 times. At that the deformed Bog oak timber shows stronger form stability, in comparison with the basic one, even under the aggressive exploitable conditions.

During the research, which is presently being carried out, other positive qualities of the Bog oak timber were found, for example, the low figure of the friction and the high dielectric resistance. The study of these Bog oak timber positive qualities and new ones continue side by side with its manufacture.

The main conclusions of the research results are as follows:

1. The modification process inside the natural oak timber during the environment effect over a long period of time in special auspicious conditions, according of the receiving of the positive final result, and also in the course of hydrothermal processing of the Bog oak timber, as a nature material. These modifications are characterized by the following:

a) By the determinant part of the chemical reactions of the modification processes, and as a result, by its irreversibility;

b) The chemical reactions have alkaline characteristics over water when the percentage oxygen content is low, as compared to the ordinary conditions. At this the pH 11-12 medium arise inside the timber.

c) Under these conditions the following occurs:

The saponification of the ester linkages of the timber ingredients in polysaccharides and between polysaccharides and lignin, and also the decay of the acetyl and half-acetyl linkages, as a result of which the polysaccharides and lignin macromolecules are depolymerized. As a result of this process and of the diffusive process fortification the most part of the timber cell walls become released in the form of the carbohydrates and lignin and transform to the water-soluble condition;

The modification of the timber cell wall water-soluble ingredients in condition of their original fractional oxidative breakdown as a result of the humification and following wedging of the nitrogen with the new appeared functional groups, which modify them into dark colored syrupy stuff, which covers timber cell walls;

The cellulose structure units (micro fibrils) disintegration on the simple fibrils and the simple fibrils contact decreasing areas, which give them an opportunity to move relative to each other, normalizing the crystal lattice.

d) In the course of the processing of the hydrothermal Bog oak timber the following occurs:

The chemical consolidation of the timber ingredients:

The water-soluble saccharides and lignin complete modification from syrupy stuff into solid water-soluble condition, and also the complete timber cell walls surface collapse;

The fixation of the timber constituents' chemical and physical changes up to the level of their complete irreversibility.

e) The defect free nature oak timber interacts with the constituents of the auspicious conditions during its long time staining, which happens as a result of its specific chemical texture, which manifests by the tanning agents inside the timber.

f) The most chemically and physically non-persistent regular oak timber constituents are modified positively during the staining.

g) The timber lattice changers affect timber new acquired qualities positively, which appeared as the chemical self-densification of the timber cell wall constituents and as the ability to deform without any defects and much easier then the natural oak timber under the defined hydrothermal conditions. The hemicelluloses and lignin modified forms get the same ability, that gives great manufacturability to the Bog oak timber.

h) Completing the procedure of natural Bog oak timber refining provide all the positive qualities and the correct organization and execution of the hydrothermal procedure to give it request exploitable humidity. It is important because in the course of this stage the chemical reactions with action of the timber constituents complete and the positive results of the whole refining process fix.

i) It possible to establish the conditions, under which the timber constituents will be modified as they would be modified in nature in separate stages and in whole. Using the techniques and methods to accelerate the chemical and physical changes afford completion of the process in terms acceptable to manufacture the timber in industry. The oak timber manufactures method to make its qualities similar to the qualities of the Bog oak timber.

In the present case, the comprehensive character of the natural oak timber manufacture is in the correct assortment agents of the processing, their quantity and quality characters individually, in combination and in aggregate for every stage of the whole technical procedure.

The ammonia was chosen as the main chemical ingredient of the method as it has the same functions in course of staining in Nature.

By the way of the following theoretical laboratory research the request content of the vapor-air-ammonia mixture was worked out, taking into consideration the compulsory condition of the air sphere percentage oxygen content artificial reduction. In specific temperature conditions and in industry reasonable terms the mixture will completely reproduce chemical and physical procedures, which are requested to refine the oak timber qualities up to the level of the Bog oak timber qualities.

Having taking into consideration the solution of the following problems: technical and ecological safety of the method, manufacturability, controllability and reducing the cost of the procedure, the operation factors limits of the work material processing and the processing assortment agents operation factors were worked out.

Half-finished product or trunks can be processed successfully even should they have a large humidity range starting from exploitable humidity and without the upper limit of the satiation, and also if they are any of linear size, which can be limited only by the sizes of the industrial equipment.

The chemical processing of the oak timber was worked out in anticipation that once made in the beginning of the cycle steam-air-ammonia blend will not necessitate any corrections till the end of the procedure, and it is necessary to control the level of temperature and pressure, that allows simplifying and decreasing of the cost of the processing.

The technological procedure of complete hydrothermal processing of the chemical processed oak timber can be processed as inside the reactor, and also inside the special drying equipment, but it should always be processed according the rates, which were worked out especially for the every separate case of the comprehensive modification. The rates of the procedure depend on the grades of the saturation of the work material, its sizes and the necessity of the Bog oak timber final humidity accomplishment.

The method of the invention can be carried out on a wide variety of wood types. The actual time of contact of the wood with the solutions in step (A) will vary depending on a variety of factors such as, for example, (1) the level of pressure within the vessel, (2) the difficulty of penetration into the particular type of wood being treated and (3) whether the wood is green wood or seasoned wood. Any type of wood, dry or green, can be treated with the solutions of the invention. Green wood generally is defined as wood containing 30% or more by weight of water. Dry or seasoned wood is defined as wood containing less than 30% by weight of water based on bone-dry wood. Examples of wood species which can be treated in accordance with the method of the invention include Southern Yellow Pine, Western Red Cedar, Douglas Fir, Inland Fir, Spruce, Hemlock, Sugar Maple, Ash, Walnut, Cherry, White Pine, Red Pine, Birch, Red Oak, White Oak, Elm, Hickory, Linden, Beech, Sycamore, etc.

From the above description it can be seen that the method and apparatus for the production of lumber identical to natural Bog oak of the present invention is able to overcome the shortcomings of prior art. Furthermore, the apparatus of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

I claim:

1. A method for the production of timber identical to natural Bog oak comprising the steps of:
a) preparing the timber materials;
b) loading the timber into a transport body;
c) loading the transport body, containing the timber into a reactor;
d) capsulizing the reactor;
e) vacuumizing the reactor;
f) blowing ammonia into the timber filed reactor;
g) increasing the temperature in the reactor;
h) repining of the timber in the reactor;
i) decreasing the temperature in the reactor;
j) hydrothermal processing of the timber in the reactor; and
k) removing the finished timber having similar qualities to Bog oak.

2. The method according to claim 1 wherein the temperature increases and decreases in the reactor are done at a tempo so that the temperature difference between external and internal timber levels are not more than 5 degrees centigrade.

3. A method for the production of timber identical to natural Bog oak comprising the steps of:
a) placing timber in an airtight reactor;
b) applying heat to the timber within the reactor;
c) creating a vacuum inside the reactor; and
d) restoring the reactor to atmospheric air pressure after the vacuum process.

4. The timber drying method as set forth in claim 3, wherein heating and vacuuming are performed at the same time.

5. The timber drying method as set forth in claim 3, wherein the process to restore air pressure is made instantaneously by opening a pressure relief valve on the airtight reactor.

6. The timber drying method as set forth in claim 3, wherein the timber has equilibrium moisture content equal or less than 6 percent.

7. The timber drying method as set forth in claim 3, wherein the timber heating process heats the timber until the surface temperature reaches substantially 120 degrees centigrade.

8. The timber drying method as set forth in claim 3, wherein the vacuuming process has a vacuuming force equal or more than 63.76 cm/Hg and a vacuuming time of at least 0.5 hour.
a) A timber impregnation method, comprising:
a ) applying heat to timber;
b) subjecting the heated timber to a vacuumed pressure;
c) covering the heated timber in ammonia at the vacuumed pressure; and
d) restoring the timber covered in ammonia at the vacuumed pressure to atmospheric air pressure while continuing to cover the timber in the ammonia.

9. The timber impregnation method as set forth in claim 9, wherein the process to restore air pressure is made instantaneously.

10. A apparatus for the production of timber identical to natural Bog oak comprising:
a) a reactor with loaded technical bogie and special thermal blowing equipment to maintain the definitely equal temperatures and gas vapor fields;
b) a vacuum pump;
c) special gas equipment, which provides the ration of the request level of the percentage oxygen content in the mixture of vapor-air-ammonia;
d) a liquid ammonia container;
e) regenerate blowing equipment, which provides the reactivation and blowing of the non-activated ammonia to the special capacity;
f) an absorbing column for the concentration of the non-activated ammonia; and
g) a control desk, which includes the control and measure control equipment, including electronic computer.
